(19) United States
(12) Patent Application Publication
(10) Pub. No.: US 2014/0142979 A1
(43) Pub. Date: May 22, 2014

(54) Medical Quick Response Codes and Information Storage and Retrieval System

(71) Applicant: Tracy Mitsunaga, Del Mar, CA (US)

(72) Inventor: Tracy Mitsunaga, Del Mar, CA (US)

(21) Appl. No.: 13/684,023

(22) Filed: Nov. 21, 2012

(51) Int. Cl. G06Q 50/24; G06K 7/14

(52) U.S. Cl. CPC G06Q 50/24; G06K 7/1417
USPC 705/3

(57) ABSTRACT

The present invention provides, in at least one embodiment, a medical quick response code comprising a barcode. The code is configured to be read by a barcode reader. The barcode reader can be an app on a mobile device such as an iPhone or Blackberry app. By scanning the code using the app, the mobile device displays critical person medical data. The critical person medical data can include emergency information such as the person's name, emergency contacts, allergies, and insurance information.

### CROSS-REFERENCE TO RELATED APPLICATIONS

The present application claims priority under 35 U.S.C. §119 to U.S. Provisional Patent Application No. 61/562,440, filed on Nov. 22, 2011, entitled “Medical Quick Response Codes and Information Storage and Retrieval System,” the disclosure of which is incorporated by reference in its entirety.

### BACKGROUND OF THE INVENTION

1. Field of Invention

The invention relates generally to medical information storage and retrieval systems and more particularly, to techniques for conveying medical information such as critical medical data and information using quick response codes.

2. Description of Related Art

A barcode is an optical machine-readable representation of data, which shows data about the object to which it attaches. Originally, one dimension (1D) barcodes represented data by varying the widths and spacing of parallel lines. Later, barcodes evolved into two dimensions (2D), including rectangles, dots, hexagons, and other geometric patterns. Although 2D systems use a variety of symbols, they are generally referred to as barcodes as well. Barcodes are used to record and transmit data such as product identifiers. Advantageously, barcodes are computer readable, but are not directly readable by humans. As such, the data contained in a barcode is somewhat encrypted. Barcodes originally were scanned by special optical scanners and interpretive software called barcode readers. Recently, barcode readers became available on common commercial devices such as printers, computer tablets, and smartphones. Barcode readers have been adopted across many industries, ranging from tracking prescriptions, shipped packages, passports, etc.

A quick response code (“QR code”) is a type of matrix 2D barcode. The QR code is one of the most popular types of 2D barcodes because it is designed to allow its contents to be decoded at high speed (i.e., fast readability) and QR codes provide relatively large storage capacity. The QR code consists of black modules arranged in a square pattern on a white background. The information encoded can be made up of any kind of data (e.g., binary, alphanumeric, symbols, etc.).

In the medical field, almost 100 million Americans have chronic conditions and millions more will develop them as America ages. Over 60 million Americans have a medical condition that should be known by medical professionals during treatment and/or in times of emergency. These medical conditions include allergies, chronic diseases, drug dependencies and genetic predispositions that can be critical during treatment and particularly in life or death situations. Studies show that accidents and medical emergencies can happen to anyone. Recent data reveals that 23% of emergency room admissions are injury or poisoning related. Another 15% are circulatory or respiratory. Emergency room personnel and paramedics often spend a large amount of time acquiring pertinent background medical information for persons who are unable to convey such information themselves. For example, a person may be unconscious and lacking any personal identification and emergency contacts. Precious treatment time can be wasted tracking down background medical information. With emergency medical services, an important factor is not only how quickly paramedics arrive at the scene, but how quickly they can begin treatment. Another important factor using up precious time and raising insurance premiums, is the large number of unnecessary tests run to determine something that is already known about the person.

U.S. Pat. No. 4,857,716 issued to Gombrich et al., the disclosure of which is herein incorporated by reference in its entirety, is directed to a person identification and verification system. Gombrich teaches a tracking system that includes static barcodes disposed on the wrists of persons and their medications. Hospital employees can rapidly scan these barcodes to ensure the medications are properly associated with the correct person.

U.S. Pat. No. 5,288,977 issued to Amendolia et al., the disclosure of which is herein incorporated by reference in its entirety, is directed to a system for imprinting person-identifying barcodes onto medical x-rays. Amendolia discloses a method for associating a person's medical images with a barcode, thus helping to ensure the records are properly paired with the correct person.

A “Yellow Dot” program has been designed to assist people and first responders in the event of an automobile crash or other medical emergency involving the person's vehicle. The program can help save lives during the critical golden hour by improving communication at a time when accident victims may be unable to communicate for themselves. The “Yellow Dot” program provides detailed medical information that can be crucial following a crash. Participants of the program receive a Yellow Dot decal, a Yellow Dot folder, and an information form with the participant's name, an identifying photo, emergency contact information, personal physicians' information, medical conditions, recent surgeries, allergies and medications being used.

The Yellow Dot decal on the driver's side rear window of a vehicle alerts first responders to check in the glove compartment for the corresponding Yellow Dot folder. Having this information following a crash helps first responders positively identify the person, get in touch with family or emergency contacts and ensures that the person's current medications and pre-existing medical conditions are considered when treatment is administered for injuries.

Another conventional device, MedicAlert IDs, include custom engraved medical ID bracelets and necklaces with a 24-hour emergency medical information service. The MedicAlert IDs are engraved with the most critical health information, such as medical conditions, prescription and over-the-counter medications and dosages, allergies, implanted medical devices, emergency contact persons, physician information, or health insurance information. Further, the MedicAlert ID has a 24-hour emergency response phone number that emergency responders and medical personnel are trained to call. The MedicAlert team relays the person's vital medical information within seconds, to ensure the person receives a safe, effective, and quick treatment. The MedicAlert team may also send electronic records to the hospital on the person's behalf and ensures the emergency contact persons are notified.

An additional conventional device, an invisible bracelet, is an emergency personal identification number (PIN) displayed on a wallet card, keychain, sticker or snap-on device for clothing. In an emergency, the person's invisible bracelet PIN can help identify them, alert first responders to the person's important health information, and notify the person's emergency contacts. When an invisible bracelet identifier is found during an emergency, a first responder can enter the PIN into any SMS-enabled (i.e., text-enabled) phone. The invisible bracelet PIN is texted to the emergency service corresponding to the invisible bracelet. The service returns an emergency alert message with the important health information previously provided by the person. First responders can interact with the service to notify the person's emergency contacts or get more detailed information that the person previously chose to share.

However, these conventional devices fall short, because they lack, among other things, a device which does not require user input, as user input leads to human error and false alerts, and lack the robustness of a QR code-based medical information system that delivers essential health information to medical providers in a quick and efficient web and smartphone based platform.

### SUMMARY OF THE INVENTION

The present invention provides a medical QR code and information retrieval system. The QR code is configured to be read by a QR code reader. The reader can be implemented as an app (i.e., application software) on any mobile device such as, but not limited to an iPhone, iPad, Windows, Android, or Blackberry. By scanning the code using the app, the mobile device acquires and displays critical person medical data. The critical person medical data can include emergency information such as the person's name, emergency contacts, 911, allergies, doctors' phone numbers, and insurance information. The listed information can be hot linked for immediate action (e.g., clicking a phone number link makes phone call such that user does not need to input any numbers).

In one embodiment of the invention, a system comprises: a code; a barcode reader configured to read the code; a person's medical data linked to the code; and an alert icon indicating the existence of the code. The person's medical data may comprise emergency person medical data comprising a person's name, an emergency contact, allergies, or insurance information. The barcode reader may comprise an app, and the app may comprise a quick response reader app on a mobile device. The code may correspond to one person and may comprise a barcode.

In another embodiment of the invention, a method comprises: locating a code using an alert icon; scanning the code using a barcode reader on a mobile device; and accessing a person's medical data on the mobile device.

In another embodiment of the invention, a device comprises: a code configured to be read by a barcode reader on a mobile device; and a person's emergency medical data linked to the code.

An advantage of the present invention is that it conveys critical data quickly. When time is of essence, persons do not have the minutes, if not hours, it sometimes takes for medical personnel to track down medical data such as insurance information and prescribed medications. When the person is unable to convey this information due to being unconscious, a seriousness injury, too much information to memorize, a poor memory, or a language barrier, the present invention easily provides the critical information. Even information as simple as an emergency contact phone number is often not remembered, and complicated information such as medications is rarely memorized.

From an individual user's perspective, the present invention is a simple and effective way to manage information for one self or for loved ones, so medical providers get the most essential health information fast. In an emergency, time is critical and can be the difference between life and death and debilitation. For everyday use, the present invention provides an easy way to store information for doctor's visits, allowing one to store all prescriptions and health conditions in a place that is easy to access and it's mobile. One can email information to their doctor, or provide the information to the emergency rooms receiving the person. The present invention also protects one when driving. Simply print out the medical forms and put them in a glove box. An alert sticker on your car window lets medics know your information is there.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a medical quick response system according to an embodiment of the invention;

FIGS. 2-3 illustrate a location for a code of the system according to an embodiment of the invention;

FIGS. 4-8 illustrate a mobile device for displaying person medical data according to embodiments of the invention; and

FIG. 9 illustrates a process of a medical quick response according to an embodiment of the invention.

### DETAILED DESCRIPTION OF EMBODIMENTS

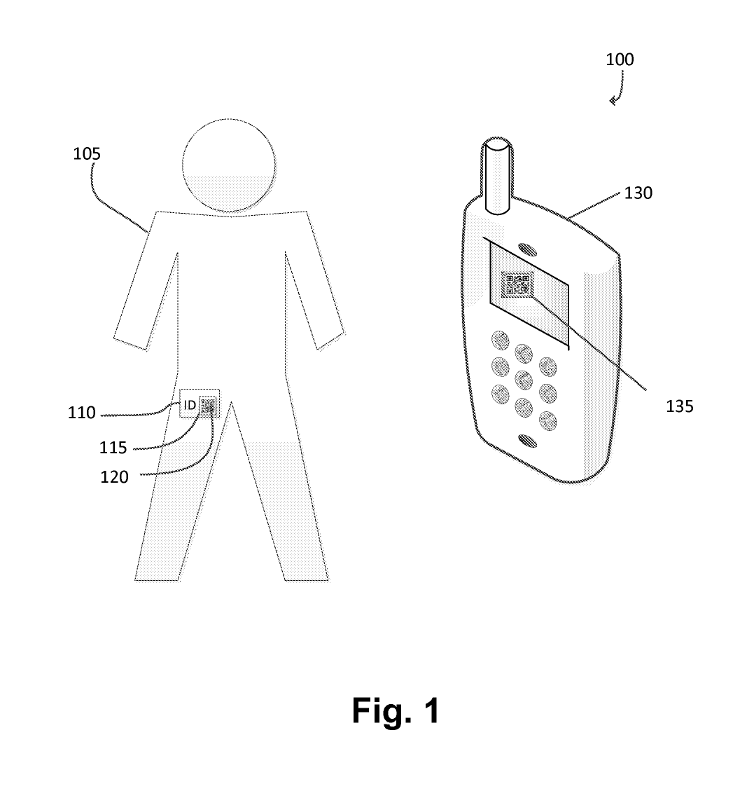

Further features and advantages of the invention, as well as the structure and operation of various embodiments of the invention, are described in detail below with reference to the accompanying FIGS. 1-9, wherein like reference numerals refer to like elements. Although the invention is described as implemented via a QR code, one of ordinary skill in the art appreciates that other types of machine readable codes and identifiers may be implemented. For example, near field communication (NFC) tags may be employed. Further, although the barcode reader disclosed herein includes a smart phone, one of ordinary skill in the art appreciates that other types of barcode readers would work as well.

The present invention provides a technique for quickly and efficiently retrieving and displaying a person's medical information to medical personnel. The system implements a unique medical quick response code (“QR code”) corresponding to an individual. The QR code can be accessed in emergency situations with any smartphone that has a QR reader app. For example, the medical QR code can be placed on an object such as a driver's license or identification card associated with the individual. The QR code may be scanned by an appropriate QR code reader executed, for example, on a tablet or smartphone such as an Apple iPhone or Blackberry. Software on the smartphone identifies a unique identification code conveyed in the QR code that provides a link to a website which is then used to retrieve medical information that is associated with an individual and stored on a remote server. The website can have password protection information and non-password protected emergency medical information. This medical information is downloaded from the server and then displayed on the smartphone in real time or near real time. Accordingly, medical personnel, civilians, or caregivers equipped with a QR code reader and Internet access may quickly retrieve a person's relevant medical information without having to question the person or locate any paperwork.

The medical information stored and retrieved may include any type of information a medical provider may find useful, the identification of which is apparent to one of ordinary skill in the art. For example, the medical information may include information such as, but not limited to, personal identification information (e.g., name, age, gender, race, emergency contacts, and guardian information), currently prescribed medications, insurance information, allergies, medical treatment history, medical providers, implanted medical devices, health directives, photograph identification, the person's residence, dates for medical information, faith, minister, pastors, lifestyle (e.g., smoker, drinker, drug user), nicknames, hospital of choice, veteran ID number, employee number, etc. The medical information can include baseline information, which the person defines before the emergency, and any other information a medical provider, particularly a first responder such as a paramedic or emergency provider, would find useful and/or necessary in treating the individual.

Some medical information is vital, and would appear first to medics. For example, blood thinners and advance directives can be vital. One type of advance directive is a do not resuscitate (DNR). A DNR can includes a request not to have cardiopulmonary resuscitation (CPR) if your heart stops or if you stop breathing, as unless given other instructions, hospital staff will try to help all people whose heart has stopped or who have stopped breathing. If a person fills in a DNR while subscribing, this information is vital. The medical information can indicate where the DNR is kept, as opposed to having a link to a scanned copy of the DNR.

The QR code may be associated with an individual in any particular manner. In a preferred embodiment, the QR code associated with an individual is implemented as a sticker that can be placed on an individual's identification card (e.g., driver's license), a card that can be carried on the person, a bracelet worn by the individual, a front door of the individual's home, a car window or dashboard driven by the individual, a refrigerator, a medicine chest, a rear view mirror hanger, etc. The sticker may be a permanent or temporary sticker and includes an appropriate notification to alert medical personnel of the existence of the QR code and that the particular individual has enrolled in a medical information storage and retrieval system.

Medical treatment personnel may access the medical information storage and retrieval system through any communications means, the identification and implementation of which is apparent to one of ordinary skill in the art, currently available or made available in the future. For example, the communications means may include cellular communications channels such as, but not limited 3G or 4G, satellite communications, local networks such as, but not limited IEEE 802.11(x) (“WiFi”), Ethernet, WiMax, or any combination thereof. Thus, a medical provider with a suitable equipped terminal having a communications means and a QR code reader may access and retrieve medical information from the medical information storage and retrieval system.

FIG. 1 illustrates a medical information storage and retrieval system 100 according to an exemplary embodiment of the invention. The system 100 includes a person (i.e., patient or emergency victim) 105 associated with an identification card 110 comprising a QR code sticker 115 featuring a unique QR code 120. The system 100 further includes a mobile device 130 having executable QR code reader software 135. The system 100 quickly provides critical data for the person 105 to medical personnel or first responder (e.g., emergency medical technician, paramedic, fireman, police officer, emergency room personnel, medical professional, nurse, doctor, etc.). The mobile device 130 can be any type smartphone, tablet, or other computer terminal capable of executing the QR code reader software 135 and scanning QR codes.

The medical information storage and retrieval system 100 further includes a remote server (not shown) comprising a database for storing the medical information associated with the person 105. The database can be a MySQL relational database to store medical information for each registered user. MySQL, where SQL stands for structured query language, is a relational database management system that runs as a server providing multi-user access to a number of databases.

The person 105 first enrolls with the medical information storage and retrieval system 100 through a website. For example, the person 105 accesses the website via a computer utilizing a web browser such as Internet Explorer. During enrollment, the person 105 enters his or her personal identification and medical information, examples of which are noted above. The person 105 may enter as much or as little information as the person 105 deems fit. At a minimum, it is desired to have identifying information such that the medical information is linked to the correct person. The person 105 can choose which information is shared with which people. The system 100 can highlight particular fields with one color to represent which information can be seen when scanning the code 120. The person 105 may select a username and password to secure access to the medical information storage and retrieval system 100. Additional security techniques may be implemented, the identification of which is apparent to one of ordinary skill in the art, in order to ensure the person's 105 privacy and secure nature of the information stored. The person 105 may utilize his/her username and password to later modify, delete, and/or supplement the information provided during enrollment. Enrollment of the person 105 may be performed by someone other than the actual person 105. For example, a doctor or nurse may enroll the person 105 and provide pertinent information associated with the person 105. Alternatively, a parent or guardian may enroll a child or dependent or an adult child can enroll a parent.

During the enrollment process, the person 105 is informed that the certain designated medical information is provided at the person's discretion and the website is not compliant with the Health Insurance Portability and Accountability Act of 1996 (HIPAA) Privacy and Security Rules. HIPAA protects the privacy of individually identifiable health information. HIPAA sets national standards for the security of electronic protected health information; and the confidentiality provisions of the Patient Safety Rule, which protect identifiable information being used to analyze patient safety events and improve patient safety. This allows certain designated information to be accessible via the QR code 120. All other information is privacy protected and only accessible via a password.

The person 105 can be any person concerned about getting fast medical treatment. An emergency can strike at any time with any person. When that happens, the person 105 would not want the medical professional to spend hours searching for emergency contacts, medication history, or insurance information. And if the person 105 is someone with serious previous or existing medical issues, such as allergies, heart attacks, epilepsies, etc., conveying information quickly and accurately can be a life or death matter. Further, the person 105 may have difficulty communicating with medical personnel due to being unconscious, being an infant or minor, or a language barrier. The person 105 may also have difficulty accurately conveying his/her medical history because the wide breadth of information or due to a poor memory.

The identification card 110 is one exemplary medium to place the sticker 115 in proximity to the person 105. Alternatively, the sticker 115 can be placed anywhere on or near the person 105. For example, the sticker 115 can be placed on the person's wallet, refrigerator, glove compartment, car window, etc. The person's medical information is not confused with the wrong person, because identifying information about the person, such as a photo, name, gender, height, weight, age, eye color, etc., can be contained on the linked medical information and the identification card 110.

The code 120 can be referred to as a QR code, medical QR code, code card, code sticker, code ID, code keychain, etc. The code 120 provides a unique identifier associated with the person 105 that allows medical personnel to access critical person data quickly and easily. The code 120 conveys a link to the information stored in a remote server. The link allows the information to be accessed, over the web, without needing to know a username or password. The unique identifier corresponds to the person 105, such that one QR code 120 is uniquely assigned to one person. In a preferred embodiment, the code 120 is a two dimensional QR code. However, the code 120 may be any encoded method of conveying information, the identification and implementation of which is apparent to one of ordinary skill in the art.

In one embodiment, the code 120 is a visual code which any QR reader can decode into a URL. The URL points to a website running hypertext preprocessor (PHP). PHP is an HTML-embedded scripting language with much of its syntax being borrowed from other programming languages (e.g., C, Java, Pert, etc.). The URL also contains the user's ID number (UserID) and a 32 character private key (QRKey). Upon receiving the web request and before delivering any header information to the client, the web server looks up the QRKey associated with the given UserID in a MySQL database and confirms that it matches the QRKey passed in the URL. Once confirmed, the web server creates a temporary 32 character public key (pub-key) for the given UserID and stores that pairing in the database on the web server and as a cookie on the user's browser. The pub-key expires after 15 minutes both in the database and on the browser cookie.

The web server then redirects the client browser to the same page but with the UserID and QRKey removed from the URL. Since no UserID or QRKey is specified in the URL, the page instead retrieves the UserID and pub-key from the browser cookie and confirms that pairing with the temporary key in the database. If the pub-key and UserID match, and the entry has not expired, the scanner of the QR Code is given access to the medical profile of the UserID. Once the cookie or database entry expire, access is denied.

As an extra level of security, the page can contain a javascript code to refresh the page after 15 minutes. This method prevents the scanner of the QR code from bookmarking the URL containing the QRKey, accessing the patient profile after the 15 minute window has passed, or viewing the patient's QRKey unless the scanner is actively looking for it. The patient can disable his QRKey and be issued a new one at any time (e.g., if the card is compromised) by visiting the QodeMed website and clicking the “generate new QR code” button.

Optionally, an alert, symbol, or notification means may be utilized to notify medical personnel of the existence of the QR code 120. For example, the person 105 may wear a bracelet/necklace (not shown) that identifies the person 105 as enrolled in the system 100. Medics or first responders are trained to look for bracelets or necklaces with medical alert information. Thus, a medic seeing the bracelet or necklace would know to look for the person's QR code 120. The person 105 can have multiple alerts, and the person 105 can put them in multiple places where emergency personnel may find them (e.g., outside of the wallet, purse, cell phone, keys, car window, refrigerator, bracelet, front door, front window of the home, necklace, medicine cabinet/chest, etc.). The alert can be the primary identifier that the person has a QR code sticker. The alert can be a symbol which becomes an industry standard, and can be placed on homes, at work, and on vehicles.

The mobile device 130 is used to scan the QR code 120. QR code reader software may be downloaded to the device 130 as an app. Upon arriving at the person 105, the first responder scans the QR code 120 via the device 130, which automatically retrieves and displays the person's 105 medical information. Thus, no information needs to be inputted by the medical personnel to obtain the person's medical information. Access to the person's medical information may not be restricted and available to all users. For example, medical providers and first responders may access the medical information that a person's chooses to share.

In an embodiment of the invention, a person's medical information will only appear for a predetermined length of time, e.g., 15 minutes, upon which it disappears from the mobile device 130 to ensure privacy. In addition, the mobile device 130 may be prohibited from storing the medical information.

In another embodiment of the invention, medical providers may forward the person's medical information to another medical provider, e.g., a hospital, via email or SMS. This enables an emergency medical technical (EMT) to forward the person's information to the closest base station or emergency hospital in the area, so the person's medical information arrives before the person 105. As a result, the hospital is better prepared for the person's arrival.

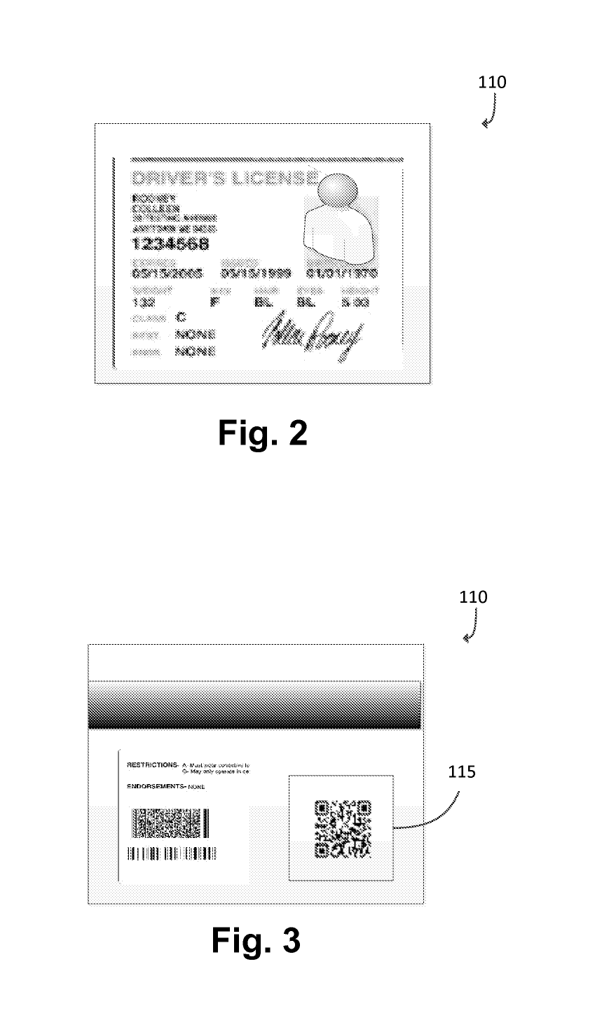

FIGS. 2-3 illustrate a location for the code 115 of the system 100 according to an embodiment of the invention. FIGS. 2-3 illustrate the identification 110 being a driver's license. FIG. 2 illustrates the front of the driver's license. The driver's license is one of the most likely items to be kept near the person 105. FIG. 3 illustrates the back of a driver's license. The back of many drivers' licenses have a blank space where the code 120 could easily attach to without blocking any relevant information.

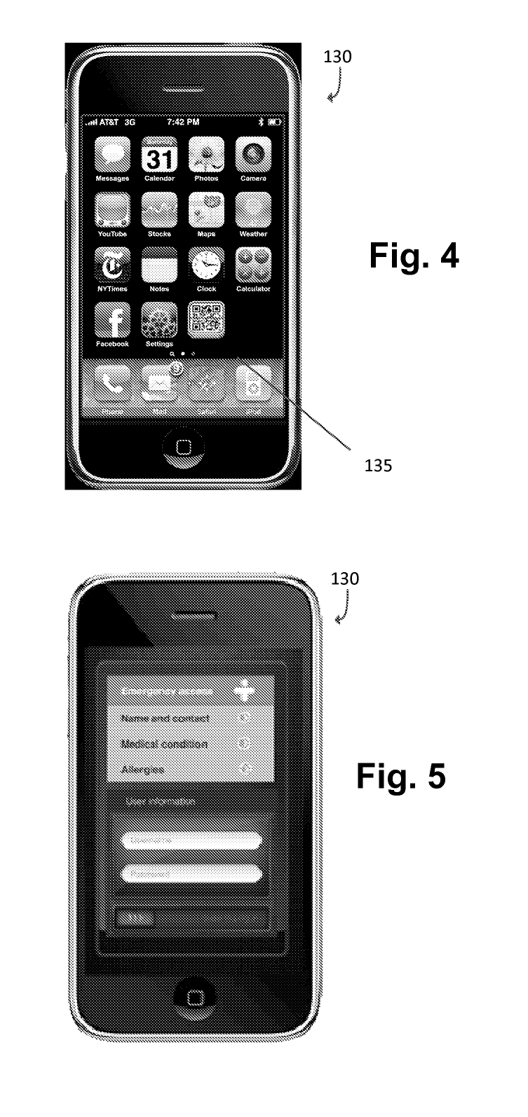

FIGS. 4-8 illustrate the mobile device 130 for displaying person medical data according to embodiments of the invention. FIG. 4 illustrates the mobile device 130 as an iPhone with the app 135 being a quick response (QR) reader app. The QR reader app can be downloaded off iTunes or another app store. The medical professional can download a free QR reader onto any smartphone and access person information instantly in three steps: locate the code 120, scan the code 120, and seamlessly retrieve and display the medical information.

FIG. 5 illustrates a logon screen on the mobile device 130 where the user enters his username and password. The ability to update from the person's smartphone or web helps ensure information remains current. In one embodiment, the user only needs to login to make changes to the medical information. As such, emergency personnel do not need to input any numbers into the app 135 to view the designated medical information. In another embodiment, the person 105 needs to enter a username and/or password to view all of the medical information.

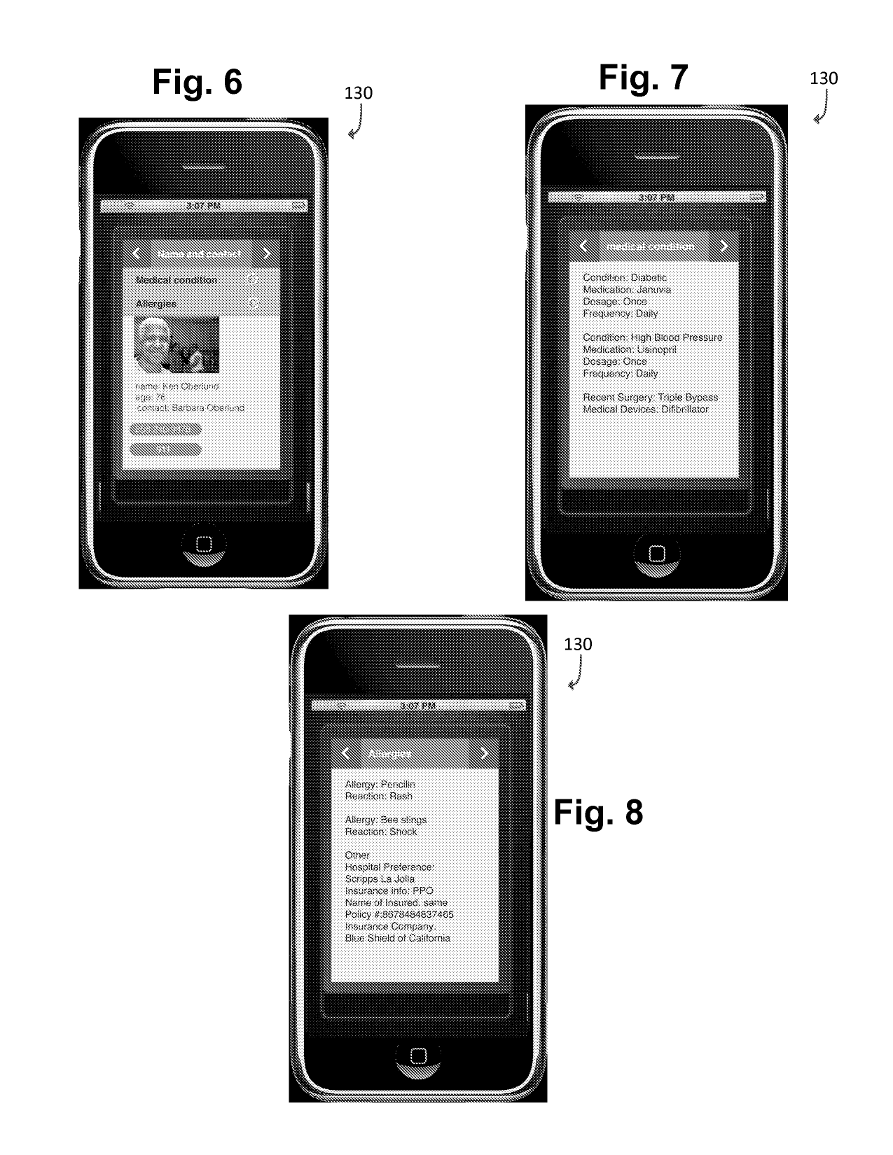

FIG. 6 illustrates a name and contact screenshot displaying the person's portrait, name, age, emergency contact and her phone number. The portrait verifies that the emergency personnel have the information for the correct person. The phone number listed is the person's emergency contact, sometimes referred to as an in case of emergency (ICE) contact. The emergency contact and 911 are hot linked for ease of calling.

FIG. 7 illustrates a medical condition screenshot displaying the person's medical conditions, medication, dosages, frequency, recent surgeries, and medical devices. Medical conditions may include high blood pressure, diabetes, epilepsy, previous heart attacks, and strokes.

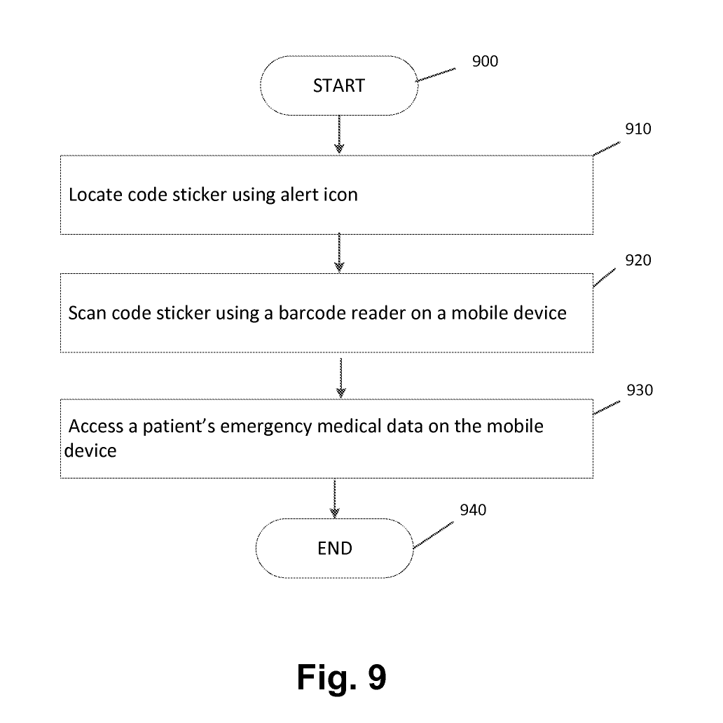

FIG. 8 illustrates an allergies screenshot displaying the person's allergies, reactions, hospital preference, physician, and insurance information. The allergy section can include what the person 105 is allergic to (e.g., bee stings, medications, food allergies, contrast agent allergies, sulfa drugs, penicillin, etc.) and the associated reactions.

Although the invention is described in the context of certain emergency person medical data, one of ordinary skill in the art appreciates that the data disclosed herein comprises anything a medic would want to know. For example, if the person 105 was unconscious or the medical professionals could not immediately reach the person's primary medical provider or relatives, the medical professional can still obtain the key helpful information they need in a quick and easy way. The person medical data is also likely to be more accurate that the person's memory.

Examples of helpful information include past medical history, languages spoken, mobile phone number, relationship status, primary physician, specialists' information, medical notes, organ donor, contact lenses, implants, and dentures. Also, the person medical data may include additional identifying information (e.g., height, weight, eye color, race, etc.), lifestyle preferences (e.g., faith, smoking, drinking, etc.), and express wishes (e.g., contact a pastor).

Additionally, advance directives can be included. An advanced directive is also referred to as an advance health care directive, a living will, a personal directive, and an advance decision. An advanced directive is instructions given by individuals specifying what actions should be taken for their health in the event that they are no longer able to make decisions due to illness or incapacity, and appoints a person to make such decisions on their behalf.

The system 100 can include privacy features. For example, the medical information can be engineered to disappear from a medic device (e.g., personal phone, pads, etc.) after 15 minutes to ensure that the information does not stay on the devices permanently. If the medical information disappears, and the medics still need it, they can simply rescan the code 120. Other privacy features prevent the person's website link from being bookmarked. Further, if the person 120 feels that their information has been compromised, the person 105 can simply request a new code and disable their old one on the website.

In one embodiment, the system 100 is directed towards emergencies. In an emergency, a rescuer will scan the person's code 120 and a screen appears within seconds. The rescuer has access to critical health information and a hyperlink to an emergency contact, the person's primary care physician, and specialists.

In an emergency, the time treatment begins is critical. Time can be the difference between life, death, and debilitation. Emergency room doctors have stated that 90% of diagnosing a person in an emergency situation is having access to information. This information includes person medical history, emergency contacts, medications, allergies, medical implants, and insurance information. And too often, that information is not readily available. In the emergency room, nurses and technicians can spend hours wasting critical time trying to obtain this information.

If the person 105 has an existing condition or is on medications, the system 100 can save his life, as in an emergency, it is difficult to recall medications and dosages. With emergency medical services, an important factor is not only how quickly paramedics arrive at the scene, but how quickly they begin administering treatment.

The system 100 is a simple and effective way to manage the person's own and loved ones medical emergency information, providing many benefits. The system 100 can save hospitals hours of time, in scenarios where time is often critical. The system 100 can be used by almost anyone, as it works with any smartphone and a QR code to access the person's medical information. The system 100 provides an important tool to manage health information and gives emergency responders access to vital medical information. The system 100 helps medics respond faster with instant information. The system 100 instantly communicates with medics when the person 105 cannot.

In addition to being an emergency response product, the system 100 can also act as a mobile medical notepad. The system 100 is great for doctors office visits, as seniors over 65 years old have an average of 3 chronic conditions and take 3-10 Rx daily. Doctors say many people come to them and cannot remember their Rx information. The person 105 can archive and share access from the desktop to smartphone. The person 105 will no longer need to struggle with the names or dosages of their medications. The person 105 will not have to remember the Rx that other specialists have written. The system 100 is useful when the person 105 has multiple specialists, medications, and dosages. The person 105 can simply print or email information to their doctor's office to place in their medical file, or have the doctor scan their code. This ideal for doctor's visits, as the person 105 can store all his prescriptions in a place that is easy to access.

In addition to being an emergency response product, the system 100 can also help families manage and share medical information. As our population ages, children are taking a more active role in the management of their parents' healthcare. Through a password protected website, the person 105 is allowed to share particular health information with their family. The person 105 chooses which information they want others to see. The system 100 is a simple and effective way to manage the health information of the person 105 and his loved ones so medical providers can access the most essential health information fast. The system 100 is ideal for parents, children, and loved ones, helping families manage their care from everywhere. Children can help track parents medication and diagnosis. Parents can help kids with epileptic, diabetic, and allergies (e.g., peanuts, bee stings, etc.).

FIG. 9 illustrates a process of a medical quick response according to an embodiment of the invention. The process starts at step 900. At step 910, the medical personnel locate the code 120. Then, at step 920, the medical personnel scan the code 120 using the barcode reader 135 on the mobile device 130. The barcode reader 135 can be a QR iPhone app. The mobile device 130 then allows access to the person's medical data at step 930. The person's medical data can include emergency information such as the person's name, emergency contacts, medical conditions, allergies, and insurance information. The process may be repeated recursively a number of times and ends at step 940.

In another embodiment of the invention, the server may send an automated email alert that is sent to the subscriber/user that lets them know their QR code has been scanned to mitigate identity fraud. The email links to a website where the user can choose to deactivate their card and activate a new QR code. In another embodiment, any information displayed on a mobile device will disappear after lapse of a predetermined time period, e.g., 15 minutes.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A system comprising:
a code;
a barcode reader configured to read the code;
a person's medical data linked to the code; and
an alert icon indicating the existence of the code.

2. The system of claim 1, wherein the person's medical data comprises emergency person medical data.

3. The system of claim 2, wherein the emergency person medical data comprises a person's name, an emergency contact, allergies, or insurance information.

4. The system of claim 1, wherein the barcode reader comprises an app.

5. The system of claim 4, wherein the app comprises a quick response reader app on a mobile device.

6. The system of claim 1, wherein the code corresponds to one person.

7. The system of claim 1, wherein the code comprises a barcode.

8. A method comprising:
locating a code using an alert icon;
scanning the code using a barcode reader on a mobile device; and
accessing a person's medical data on the mobile device.

9. A device comprising:
a code configured to be read by a barcode reader on a mobile device; and
a person's emergency medical data linked to the code.
